(19) United States
(12) Patent Application Publication
(10) Pub. No.: US 2016/0055342 A1
(43) Pub. Date: Feb. 25, 2016

(54) DEVICE AND METHODS TO CONTROL INFORMATION OUTPUTTING ON COMPUTING DEVICE

(71) Applicant: Giuseppe BIVONA, (US)

(72) Inventor: Giuseppe Bivona, London (GB)

(21) Appl. No.: 14/782,038

(22) PCT Filed: Dec. 18, 2013
(86) PCT No.: PCT/US2013/075984

§ 371 Date: Oct. 2, 2015

(51) Int. Cl. G06F 21/62

(52) U.S. Cl. CPC G06F 21/62; G06F 21/629

(57) ABSTRACT

A computing device and method are provided for exchanging signals therewith being configurable between different outputting control modes. An outputting control mode selection is input via a graphical interface. Instructions enable the outputting of information to a data file in the memory when the information is either not designated or is designated as ‘Displayable’ or ‘Not-Displayable’ in a first mode; disable the outputting of information to a data file in the memory when the information is designated as ‘Not-Displayable’ and to enable the outputting of information to a data file in the memory when information is not designated ‘Not-Displayable’ in a second mode; and disable the outputting of information to a data file in the memory when the information is not designated as ‘Not-Displayable’ and to enable the outputting of information to a data file in the memory when the information is designated as ‘Not-Displayable’ in a third mode.

### BACKGROUND

1. Technical Field

The present disclosure is related to the field of content protection and privacy enhancement for computing devices, such as a personal computer, a handheld computer, a personal digital assistant, a cellular telephone, a network appliance, a camera, a smart phone, an enhanced general packet radio service (EGPRS) mobile phone, a network base station, a media player, a navigation device, an email device, a game console, or other electronic device or a combination of any two or more of these data processing devices or other data processing devices subsequently generically referred as the computing device, the mobile communication device, the mobile device, the portable device or simply the device.

2. Introduction

It is a general misconception that portable digital devices such as mobile communication devices are personal equipment which is not shared among multiple users (individual or enterprises). Confidentiality of the information (e.g. text messages, emails, call logs, pictures and so forth) stored into the device, predominantly relies on a password which is entered when the device is turned on or woken up or when accessing the password lock settings and features such as the auto-lock. In some cases users choose not to activate the password or to disable the auto-lock feature, increasing the risk that confidential or sensitive information incoming or stored into the device can be accessed.

In fact, the anecdotal evidence suggests that: i) devices can be occasionally left unlocked when unattended, exposing them to a risk that a person other than the owner can access the content; ii) the relationship between individuals—business and personal—makes it difficult in practice to deny access to the device or simply restrict access to selected applications; iii) information can reach the device at anytime, including when the owner is not in the position to handle it with confidentiality; iv) devices are lost or stolen also whilst being unlocked.

In many cases, the majority of information (business or personal) stored on the device may not pose a problem if accessed accidently or without the owner's permission, but there are specific information (for instance children or family pictures, business sensitive notes, clients' contacts, email or messages and so forth) that the owner of the device may want to protect against any unforeseen circumstances of a third party accessing the device.

The use of portable device could also result in a limitation to the owner's privacy in relation to telephone calls, text messages, email and other communication from an unknown identifier or entity (e.g. communication from an undisclosed identifier or entity or from a disclosed identifier or entity which is unknown to the user) or from a known identifier or entity whose outputting of information the device's owner may possibly want to disallow.

3. Related Art

US2013/0055378 A1 discloses a method for controlling permissions of a mobile communication device selecting an access control mode for an application, the access control mode being associated with one or more permissions to manage resource. U.S. Pat. No. 8,434,153 B2 discloses a method for a user request to display an application while the device is locked. US 2004/0088588 A1 discloses a method to provide rapid access to resources that differentiate between applications, data and devices that require protection to be accessed without entry of a password and discloses a restricted mode of operation in which specified applications are able to perform a limited number of operations prior to the entry of a password.

4. Problems to be Solved by the Invention

The present invention has as an objective to ensure protection of a data file, also generically referred to herein as ‘information’, by disabling the outputting of selected information comprising audio, visual and any other sensorial content, alerts, alarms and notifications or a components thereof, without restricting access to the application which stores, receives, generates and processes the information other than in relation to outputting functionality and only limited to specific designated information that the user intends to protect.

The present invention also allows the user to create a partition of information to enable or disable outputting of information for individual data file or groups of data files and to disable outputting of communication from unidentified senders or from identified senders whose outputting of communication the user intend to disable.

For the purpose of the present specification of the invention, the words ‘information’, ‘record’, ‘data’ and ‘data file’ are deemed to be interchangeable synonymous and the words ‘data’ and ‘data file’, are deemed to include also metadata associated with a data or a data file.

### SUMMARY

Exemplary embodiments of the present invention provide a method and a digital device to selectively enable or disable, subject to entering valid authorization, the outputting of information.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

An exemplary embodiment of the present invention provides a method of and system to enable or disable the outputting of information comprising selecting an outputting control mode (′ON′ or ‘OFF’ or ‘REVERSE’) and an information designation status (‘Displayable or ‘Not-Displayable’), wherein the outputting control mode ‘OFF’ is configured to enable the outputting of a data file which is either not designated or is designated ‘Displayable’ or Not-Displayable′; the outputting control mode ‘ON’ is configured to disable the outputting of a data file designated as ‘Not-Displayable’ and enable the outputting of a data file which is not designated as Not-Displayable′; and the outputting control mode ‘REVERSE’ is configured to disable the outputting of a data file which is not designated as ‘Not-Displayable’ and enable the outputting of a data file designated as Not-Displayable′.

In one exemplary embodiment of the claimed subject matter, outputting control mode (′ON′ or ‘OFF’ or ‘REVERSE’) is configured to switch from at least one configuration to another after entering valid authorization data and at least one data file in the memory is toggled between being designated as ‘Not-Displayable’ or ‘Displayable’ according to a designation method. The designation method includes (a) manually designating a data file with a user command; (b) executing predetermined instructions as set in the systems, apparatus and computers program products which generate, receive, store, or process the data file; and (c) detecting and applying the designation assigned by another device which originated the data file. Information which is not expressly designated ‘Not-Displayable’ according to any prior methods, is set as designated ‘Displayable’ for outputting control mode ‘ON’, ‘OFF’ and ‘REVERSE’.

According to the claimed subject matter, a computing device is provided comprising a memory, a processor, an operating system, I/O peripherals and a plurality of resources connected to the processor for exchanging signals therewith being configurable between an outputting control mode of ‘ON’, ‘OFF’ and ‘REVERSE’; an input device connected to the processor for inputting an outputting control mode selection via a graphical interface; instructions operable on the processor for causing the processor (a) when the outputting control mode selection is ‘OFF’, to enable the outputting of information to a data file in the memory when the information is either not designated or is designated as either ‘Displayable’ or Not-Displayable′; (b) when the outputting control mode selection is ‘ON’, to disable the outputting of information to a data file in the memory when the information is designated as ‘Not-Displayable’ and to enable the outputting of information to a data file in the memory when information is not designated ‘Not-Displayable’; and (c) when the outputting control mode selection is ‘REVERSE’, to disable the outputting of information to a data file in the memory when the information is not designated as ‘Not-Displayable’ and to enable the outputting of information to a data file in the memory when the information is designated as ‘Not-Displayable’ wherein the outputting control mode selection is configured to require valid authorization data for switching from at least one configuration to another and to enable at least one data file in the memory to be toggled between being designated ‘Not-Displayable’ or ‘Displayable’.

According to an embodiment of the claimed subject matter, an input device is provided connected to the processor for inputting an information designation status as ‘Displayable’ or ‘Not-Displayable’ and instructions operable on the processor for causing the processor to designate a data file in the memory either ‘Displayable’ or ‘Not-Displayable’ according to predetermined instructions or by detecting and adopting the designation status associated with the data file as applied by a computing device.

According to an embodiment of the claimed subject matter, wherein the outputting control mode selection ‘ON’ is configured to disable the outputting of a data file designated as ‘Not-Displayable’ or metadata associated with the data file designated as ‘Not-Displayable’ and the outputting control mode selection ‘REVERSE’ is configured to disable the outputting of a data file which is not designated as ‘Not-Displayable’ or metadata associated with the data file which is not designated as Not-Displayable′.

According to an embodiment of the claimed subject matter, wherein an address book application and at least one communication application are provided, and the at least one communication application is configured to designate as ‘Not-Displayable’ a communication associated with at least one contact entry in the address book application designated as ‘Not-Displayable’ upon receipt or transmission of the communication and to designate as ‘Displayable’ a communication associated with at least one contact entry in the address book application which is not designated as ‘Not-Displayable’ upon receipt or transmission of the communication.

According to an embodiment of the claimed subject matter, wherein at least one program application is provided comprising an alternatively reversible user command subsequently referred as ‘Mark Displayable’ (′Mark Not-Displayable′) enabling individual information or group of information to be toggled between being designated as either ‘Displayable’ or ‘Not-Displayable’ wherein a data file generated by the application being configured ‘Mark Displayable’ is designated as ‘Displayable’ and a data file generated by the application being configured ‘Mark Not-Displayable’ is designated as ‘Not-Displayable’.

According to an embodiment of the claimed subject matter, wherein when the outputting control mode is selected as ‘ON’, the processor is further configured to disable output including alarms, alerts and notification associated with a data file designated as ‘Not-Displayable’ and when the outputting control mode is selected as ‘REVERSE’, the processor is further configured to disable output including alarms, alerts and notification associated with a data file which is not designated as Not-Displayable′.

According to an embodiment of the claimed subject matter, wherein the data file designated as ‘Not-Displayable’ is a contact from an address book, and the alarm, alert and notification indicate reception of a communication from the contact.

According to an embodiment of the claimed subject matter, a method is provided to control the outputting of information on computing devices and program applications the computing devices comprising a process and a computer-readable non-transitory memory, the program applications being stored in the memory in the form of computer readable instructions, the method comprising a process to designate information as ‘Displayable’ or ‘Not-Displayable’ and to designate an outputting control mode as ‘OR’ or ‘OFF’ or ‘REVERSE’, the process implemented by the instructions configured to: (a) to enable outputting to a data file in the memory which is not designated or is designated as either ‘Displayable’ or ‘Not-Displayable’: (b) to disable outputting to a data file in the memory designated as ‘Not-Displayable’ and to enable outputting to any data file in the memory which is not designated ‘Not-Displayable’ when the outputting control mode selection is ‘ON’; and (c) to disable outputting to a data file in the memory which is not designated ‘Not-Displayable’ and to enable outputting to a data file in the memory designated as ‘Not-Displayable’ when the outputting control mode selection is ‘REVERSE’, wherein the outputting control mode selection is configured to require valid authorization data for being permitted to switch from at least one configuration to another and to enable at least one data file in the memory to be toggled between being designated as ‘Not-Displayable’ or ‘Displayable’.

According to an embodiment of the claimed subject matter, wherein the information designation method is a user command to manually designate an individual data file or a group of data files.

According to an embodiment of the claimed subject matter, wherein the information designation method is a program application configured to designate data files according to predetermined instructions.

According to an embodiment of the claimed subject matter, wherein the information designation method is the process to detect and apply the designation assigned to a data file by a device from which the data file has been transmitted.

According to an embodiment of the claimed subject matter, wherein the outputting control mode selection ‘ON’ is configured to disable the outputting of a data file designated as ‘Not-Displayable’ or metadata associated with the data file designated as ‘Not-Displayable’ and the outputting control mode selection ‘REVERSE’ is configured to disable the outputting of a data file which is not designated as ‘Not-Displayable’ or metadata associated with the data file which is not designated as Not-Displayable′.

According to an embodiment of the claimed subject matter, wherein the data file is configured to be toggled between being designated as ‘Displayable’ and designated as ‘Not-Displayable’ through a user selectable alternatively reversible ‘Mark Displayable’ and ‘Mark Not-Displayable’ command that is selectable through a graphical user interface, wherein the selection input using the graphical use interface causes the processor to enable or disable the outputting of the data file according to a predetermined outputting control mode selection ‘ON’ or ‘OFF’ or ‘REVERSE’.

According to an embodiment of the claimed subject matter, wherein the graphical user interface includes a plurality of inputs including a specified menu entry selection and a thumbnail selection.

According to an embodiment of the claimed subject matter, wherein the program application is an application that processes incoming communications, the application further comprising determining whether the outputting control mode selection is ‘ON’, ‘OFF’ or ‘REVERSE’; setting through a user graphical interface the default designation status as either ‘Displayable’ or ‘Not-Displayable’ of the record of a communication from a sender whose identifier does not correspond to the identifier of any contact stored in an address book application; receiving a communication from a sender, the communication including an identifier of the sender; comparing the identifier of the sender of the communication with the identifiers of a set of contacts stored in an address book application; if the identifier of the sender of the communication does not correspond to the identifier of any contact stored in an address book application, saving a record of the communication and designating the record of the communication as either ‘Displayable’ or ‘Not-Displayable” according to the setting of default designation status; if the identifier of the sender corresponds to at least one identifier of a contact stored in an address book application which is designated ‘Not-Displayable’, saving a record of the communication and designating the record of the communication as Not-Displayable′; if the identifier of the sender corresponds to the identifier of one or more contacts stored in an address book application, none of which is designated ‘Not-Displayable’, saving a record of the communication and designating the record of the communication as ‘Displayable’; enabling outputting of the communication if the record of the communication is designated either ‘Displayable’ or ‘Not-Displayable’ when the outputting control mode selection is ‘OFF’; enabling outputting of the communication if the record of the communication is designated ‘Displayable’ and disabling the outputting of communication if the record of the communication is designated as ‘Not-Displayable’ when the outputting control mode selection is ‘ON’; and enabling outputting of the communication if the record of the communication is designated ‘Not-Displayable’ and disabling the outputting of communication if the record of the communication is designated as ‘Displayable’ when the outputting control mode selection is ‘REVERSE’.

According to an embodiment of the claimed subject matter, wherein the method further comprises the steps of: if the record of the communication is designated as ‘Not-Displayable’, disabling access to the record of the communication when the outputting control mode selection is ‘ON’ and if the record of the communication is designated as ‘Displayable’, disabling access to the record of the communication when the outputting control mode selection is ‘REVERSE’.

According to an embodiment of the claimed subject matter, wherein the communication is selected from at least one of a telephone call, an email, or a text message.

According to an embodiment of the claimed subject matter, wherein outputting of the communication comprises an acoustic alert, alarm or notification.

According to an embodiment of the claimed subject matter, wherein outputting of the communication comprises displaying text or an icon on a display device.

According to an embodiment of the claimed subject matter, wherein the program application comprises a user selected binary setting mode of ‘Mark Displayable’ or ‘Mark Not-Displayable’ that is selectable through a graphical user interface, where the selection input by the graphical interface causes the application to designate as ‘Displayable’ a data file or a group of data files generated by the application in the setting mode ‘Mark Displayable’ and to designate as ‘Not-Displayable’ a data file generated by the application in the setting mode ‘Mark Not-Displayable’.

### BRIEF DESCRIPTION OF THE DRAWINGS

FIG. 1 is an exemplary computing device comprising a generic mobile communication device hosting the present invention.

FIG. 2 with FIG. 2A and FIG. 2B is a schematic diagram of an exemplary generic architecture of a mobile communication device hosting the present invention, comprising a memory (expanded in FIG. 2A) and peripherals (expanded in FIG. 2B)

FIG. 3 is a flowchart illustrating a method for allowing to select the outputting control mode status (′ON′ or ‘OFF’ or ‘REVERSE’) of a computing device or of a program application according to an exemplary embodiment of the present invention.

FIG. 4 is a flowchart illustrating a method for allowing to designate the information status (‘Displayable’ or ‘Not-Displayable’) according to an exemplary embodiment of the present invention.

FIG. 5 is a flowchart illustrating a method for enabling or disabling the outputting of information comprising audio, visual and other sensorial contents, alerts, alarms and notifications according to the outputting control mode (′ON′ or ‘OFF’ or ‘REVERSE’) and information designation status (‘Displayable’ or Not-′Displayable′) according to an exemplary embodiment of the present invention.

FIG. 6 is a flowchart illustrating a method for enabling or disabling the outputting of information according to method of FIG. 4 and FIG. 5 wherein the program application is an application that processes incoming communications.

FIG. 7 illustrates an example implementation method of a user command to toggle information or the device and program application process to generate information between being designated as either ‘Displayable’ or ‘Not-Displayable’.

FIG. 8 illustrates an example embodiment of a graphical interface for a user command to toggle information between being designated as either ‘Displayable’ or ‘Not-Displayable’.

FIG. 9 illustrates an example implementation method for outputting control mode instructions to configure, set, change, enable, disable valid authorization for outputting control mode being permitted to switch from at least one configuration to another.

FIG. 10 is a flowchart illustrating an example implementation method for outputting control mode being permitted to switch configuration after entering valid authorization.

Like reference numbers and designations in the various drawings indicate like elements.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is within the knowledge of one skilled in the art to combine and effect such feature, structure, or characteristic in connection with other embodiments whether or not explicitly described, and such combination is intended to be within the scope of the invention.

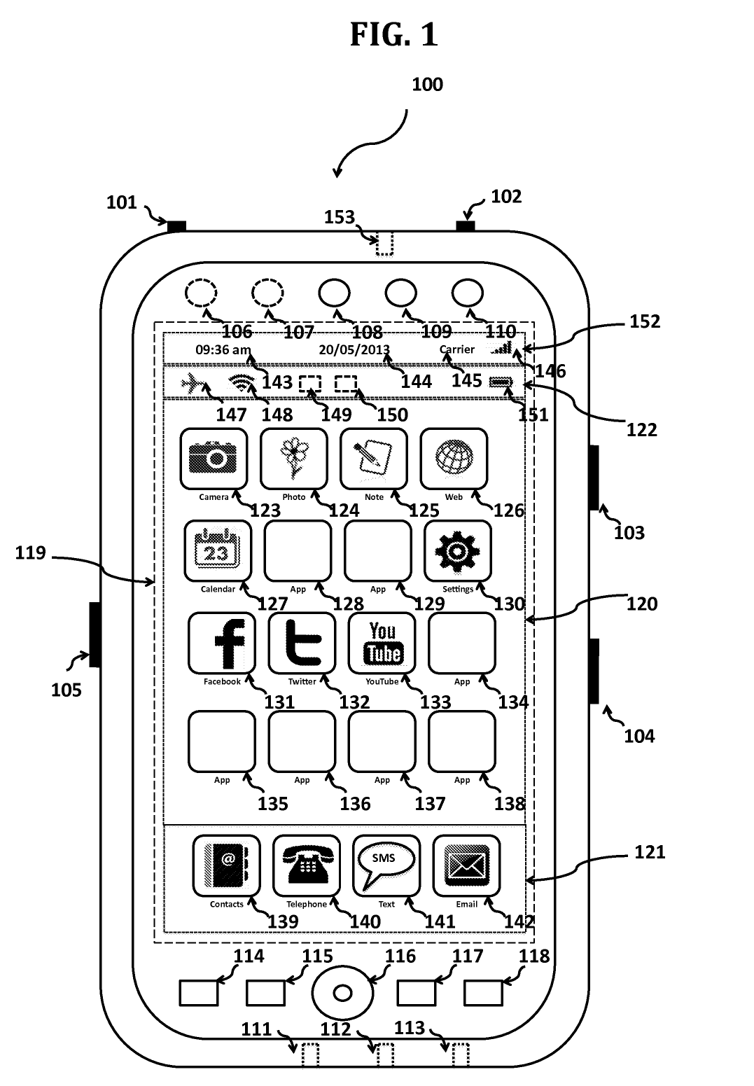

FIG. 1 illustrates a block diagram of an example computing device consisting of a generic mobile communication device 100 as an exemplary platform on which methods and apparatus of the present invention can be implemented. Those with skills in the computer arts will recognise that the disclosed embodiments have relevance in a wide range of other platforms and can be implemented in software, hardware or a combination of both. Further, each of the display objects, sensors, and LEDs whose functions are described below can be implemented in known ways, and so no detailed discussion of how to implement them is included.

In some implementations, the mobile communication device 100 includes a multi touch-sensitive display 119 for providing the user access to various system objects and for conveying information to the user. In some implementations, the graphical user interface can include one or more display objects such as icons 120, 121, 122 and 152 or more.

Each of the display objects (or icons) 120, 121, 122, 152 can be a graphic representation of a system object. Some examples of system objects include device functions, applications, windows, files, alerts, notifications, events, or other identifiable system objects. Touching one of the objects can invoke the corresponding functionality. In some implementations, a user can configure the display objects 120 and 121 e.g., a user may specify which display objects are displayed and may download additional applications or other software that provides other functionalities and corresponding display objects.

In some implementations, the display object 120 can include additional display objects such as a Camera object 123, a Photos object 124 a Note object 125, a Web Browser object 126, a Calendar object 127, a Settings object 130, social network objects such as Facebook® (object 131) and Twitter® (object 132), YouTube® object 133 plus other native and not native third party applications, including downloaded applications, generically indicated as object (or icon) 128, 129, 134, 135, 136, 137 and 138.

In some implementations, the display object 121 include primary shortcuts applications allowing access to important applications such as Address Book 139, Telephone 140, Text Messaging 141 and Email 142.

In some implementations, the display objects 122 and 152 include indicator icons showing status information such time 143 and date 144, network provider 145, signal strength 146, flight mode 147, wireless connections 148, battery level 151 and others generically indicated as 149 and 150.

In some implementations, the mobile communication device 100 can implement network distribution functionality. For example, the functionality can enable the user to take the mobile communication device 100 and its associated network while travelling. In particular, the mobile communication device 100 can extend Internet access (e.g., via Wi-Fi) to other wireless devices in the vicinity. For example, mobile communication device 100 can be configured as a base station (or “hot spot”) for one or more devices. As such, mobile communication device 100 can grant or deny network access to other wireless devices.

In some implementations, upon invocation of particular device functionality, the graphical user interface of the mobile communication device 100 changes, or is augmented or replaced with another user interface or user interface elements, to facilitate access to particular functions associated with the corresponding device functionality. For example, in response to a user touching the Address Book object 139, the graphical user interface of the touch-sensitive display 121, may present display objects related to various contact directory functions; touching the Telephone object 140 may cause the graphical user interface to present display objects related to various telephone functions; and touching the Text Messaging object 141 may cause the graphical user interface to present display objects related to various text message processing functions; likewise, touching of the E-mail object 142 may cause the graphical user interface to present display objects related to various e-mail functions.

In some implementations, other buttons included are a menu button 114 to open the menu in an application; button 115 to restore the top-level graphical user interface environment of FIG. 1 bearing in mind that in some implementations, each corresponding device functionality may have corresponding ‘home’ display objects displayed on the touch-sensitive display 119, and pressing the ‘home’ display object can restore the top-level graphical user interface environment of FIG. 1; a joystick or directional pad 116 enabling “up,” “down,” “left,” and “right” movement or register diagonal movement (e.g., “down/left”, “up/right”). In still other embodiments, pushing the joystick 116 into or towards the mobile communication device may initiate functionality; a back key button 117 to step backwards when navigating a menu or web page; a search button 118 to access a particular search engine to search items on the internet.

In some implementations, other buttons included are lock key button 101 to lock or unlock the touch screen; a play/pause a media file or mute a call button 102; a power key button 103 to power the phone on and off; one or more convenience key such as autofocus or take a picture 104; and a volume button 105.

In some implementations, the mobile communication device 100 can include one or more input/output (I/O) like by way of example a speaker 110 and a microphone 111 to facilitate voice-enabled functionalities, such as telephone and voice mail functions. In some implementations, additional I/O device(s) can be included generically indicated as 113. An audio jack 153 can also be included for use of headphones and/or a microphone. In some implementations, the mobile communication device 100 may also include light emitting diodes (LEDs) 109.

In some implementations, the mobile communication device 100 can include one or more sensor devices like, by way of example, a proximity sensor 106 to facilitate the detection of the user positioning the mobile communication device 100 proximate to the user's ear and, in response, to disengage the touch-sensitive display 119 to prevent accidental function invocations. In some implementations, the touch-sensitive display 119 can be turned off to conserve additional power when the mobile communication device 100 is proximate to the user's ear. Other sensors can also be used, generically indicated as 107.

Accordingly, display objects and/or media can be presented according to a detected orientation, e.g., portrait or landscape. In some implementations, the mobile communication device 100 may include circuitry and sensors for supporting a location determining capability, such as that provided by the global positioning system (GPS) or other positioning system (e.g., systems using Wi-Fi access points, television signals, cellular grids, Uniform Resource Locators (URLs)). In some implementations, a positioning system (e.g., a GPS receiver) can be integrated into the mobile communication device 100 or provided as a separate device that can be coupled to the mobile communication device 100 through an interface (e.g., port device 112) to provide access to location-based services.

The mobile communication device 100 can also include a camera lens and sensor 108. In some implementations, the camera lens and sensor 108 can be located on the back surface of the mobile communication device 100. The camera can capture still images and/or video.

In some implementations, a port device 112, e.g., a Universal Serial Bus (USB) port, or a docking port, or some other wired port connection, can be included. The port device 112 can, for example, be utilized to establish a wired connection to other computing devices, such as other communication devices 100, a personal computer, a printer, or other processing devices capable of receiving and/or transmitting data. In some implementations, the port device 112 allows the mobile communication device 100 to synchronize with a host device using one or more protocols.

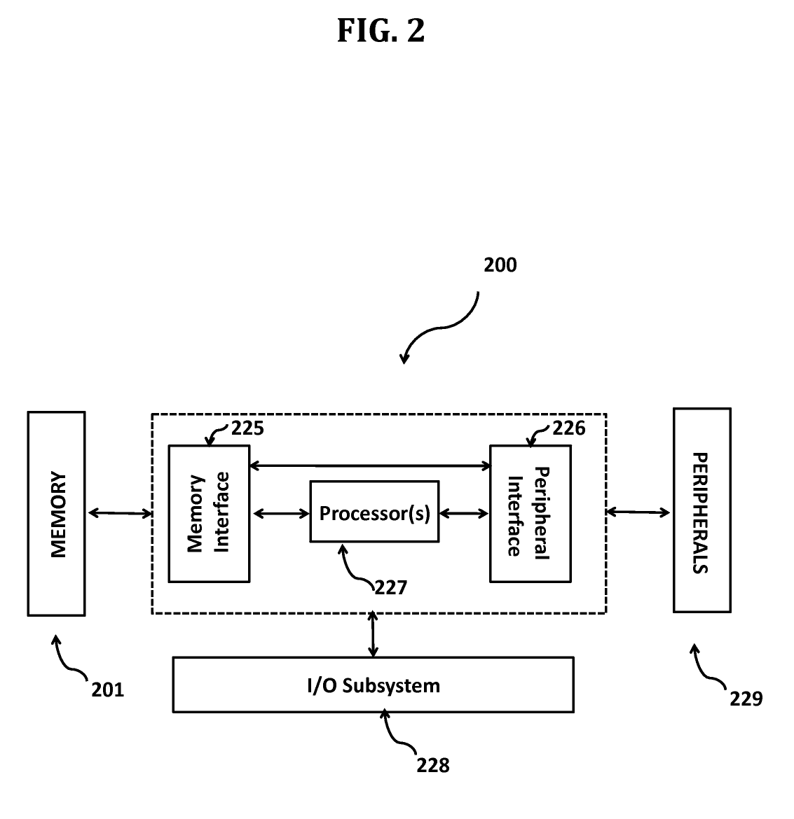

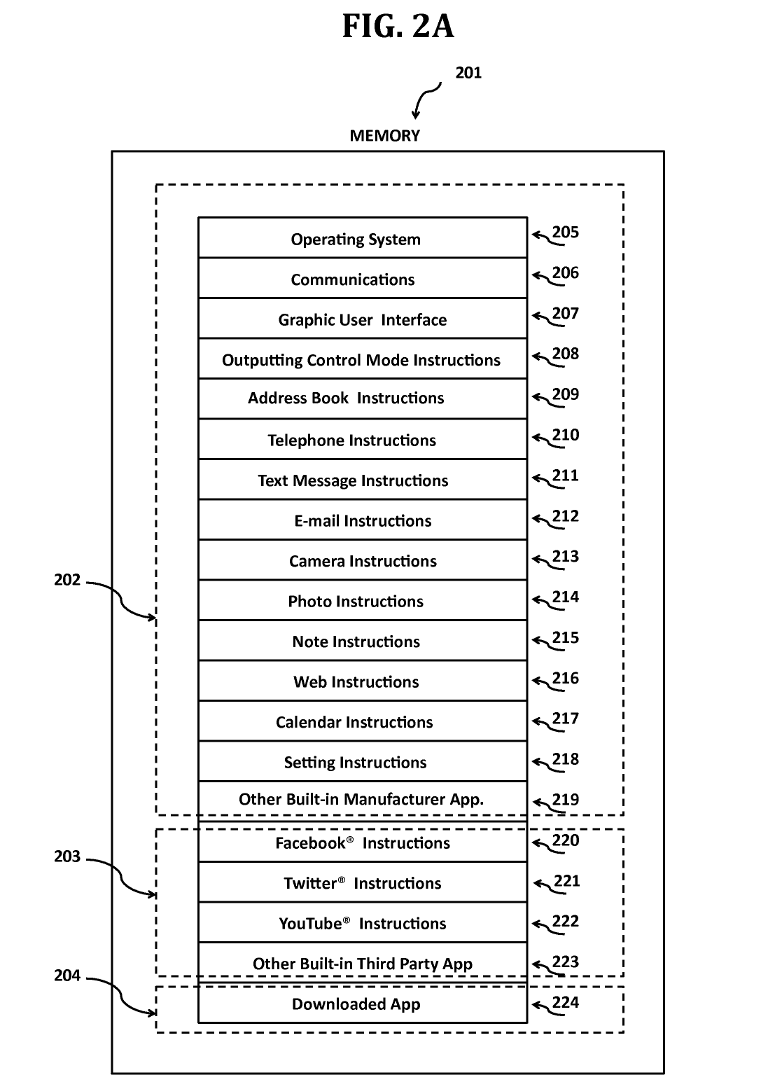

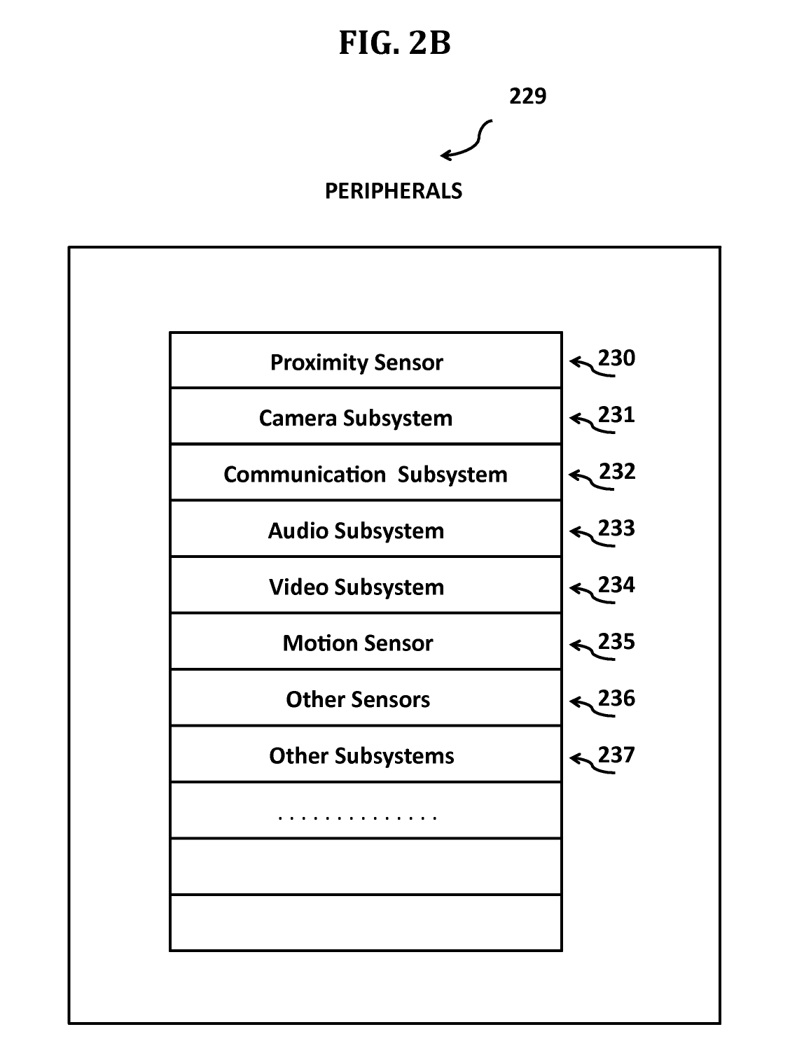

FIG. 2 is a schematic diagram 200 of an exemplary generic architecture of a mobile communication device hosting the present invention. The generic architecture of mobile communication device 100 (see FIG. 1) can include a memory 201, expanded in FIG. 2A, a memory interface 225, one or more central processors units 227, a peripherals interface 226, a I/O subsystem 228 and peripherals 229 expanded in FIG. 2B. The memory interface 225, the one or more processors 227 and the peripherals interface 226 can be separate components or can be integrated in one or more integrated circuits. One or more communication buses or signal lines can couple the various components in the mobile communication device 100 (see FIG. 1).

Peripherals 229, including sensors 230 and 235 and subsystems 231, 232, 233 and 234, can be coupled to the peripherals interface 226 to facilitate multiple functionalities. Other device subsystems and other sensors generically referred as 237 and 236 can also be connected to the peripherals interface 226.

The I/O subsystem 228 can include a touch screen controller and/or other input controller(s). The touch-screen controller can be coupled to a touch screen.

The other input controller(s) can be coupled to other input/control devices, such as one or more buttons, rocker switches, thumb-wheel, infrared port, USB port, and/or a pointer device such as a stylus. The one or more buttons (not shown) can include an up/down button for volume control of the speaker and/or the microphone.

The memory interface 225 can be coupled to memory 201. The memory 201 can include high-speed random access memory and/or non-volatile memory, such as one or more magnetic disk storage devices, one or more optical storage devices, and/or flash memory.

The memory 201 can store an operating system 205, such as UNIX, OS X, WINDOWS, Darwin, RTXC, LINUX, or other operating systems. The operating system 205 may include instructions for handling basic system services and for performing hardware dependent tasks. In some implementations, the operating system 205 handles timekeeping tasks, including maintaining the date and time (e.g., a clock) on the mobile communication device 100 (see FIG. 1). In some implementations, the operating system 205 can be a kernel (e.g., UNIX kernel).

The memory 201 can store built-in native instructions 202, built-in third party application 203 such as such as Facebook® instructions 220, Twitter® instructions 221, YouTube® instructions 222 and other applications generically referred to as 223 and not native applications 204 such as downloaded applications generically referred to as 224. The memory 201 can also store data, including but not limited to documents, images, video files, audio files, and other data.

The memory 201 may also store communications instructions 206 to facilitate communicating with one or more additional devices, one or more computers and/or one or more servers. The memory 201 may include graphical user interface instructions 207 to facilitate graphic user interface processing; Address Book instructions 209 to perform address book functions; Telephone instructions 210 to facilitate telephone related processes and functions; Text Messaging instructions 211 to facilitate text messaging related processes and functions; E-mail instructions 212 to facilitate email related process and functions; Camera instructions 213 to facilitate sill photo and video functions; Photo instructions 214; Note instructions 215; Web Browsing instructions 216 to facilitate web browsing-related processes and functions; Calendar instructions 217; Setting instructions 218 and other native function generically referred as 219.

In one embodiment of the invention, memory 201 stores instructions 208 to facilitate operating outputting control mode.

Each of the above identified instructions and applications can correspond to a set of instructions for performing one or more functions described above as would be understood by one of ordinary skill in the art. These instructions need not be implemented as separate software programs, procedures or modules. The memory 201 can include additional instructions or fewer instructions. Furthermore, various functions of the mobile communication device 100 (see FIG. 1) may be implemented in hardware and/or in software, including in one or more signal processing and/or application specific integrated circuits in ways that are known to one of ordinary skill in the art.

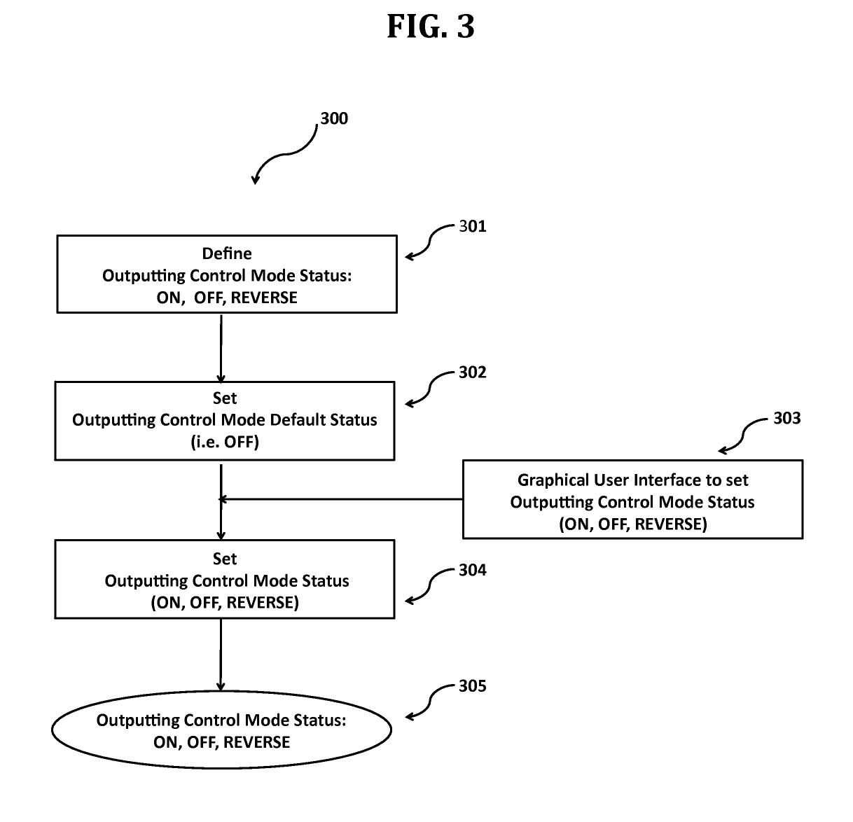

FIG. 3 is a flowchart illustrating a method 300 for allowing a user to select the outputting control mode status (‘ON’ or ‘OFF’ or ‘REVERSE’) of a computing device or a program application according to an exemplary embodiment of the present invention.

In one embodiment of the invention, instructions 301 define the status (′ON′ or ‘OFF’ or ‘REVERSE’) of the outputting control mode and instructions 302 set the default status (e.g., ‘OFF’) of outputting control mode.

Graphical user interface instructions 303 facilitates the setting of the outputting control mode to one of three modes: ‘ON’, ‘OFF’, or ‘REVERSE’.

Instructions 304 sets the outputting control mode to ‘ON’, ‘OFF’ or ‘REVERSE’.

In some implementation the outputting control mode status 305 activates an indicator icon in display object 119 (see FIG. 1) showing status information of the state of the outputting control mode as ‘ON’, ‘OFF’ or ‘REVERSE’.

Each of the above identified instructions and applications can correspond to a set of instructions for performing one or more functions described above. These instructions need not be implemented as separate software programs, procedures or modules.

The process and logic flaws described in this specification can be performed by one or more programmable processors executing one or more computer programs to perform functions by operating an input data and generating output. The process can also be implemented as, special purpose logic circuitry or any application-specific integrated circuit.

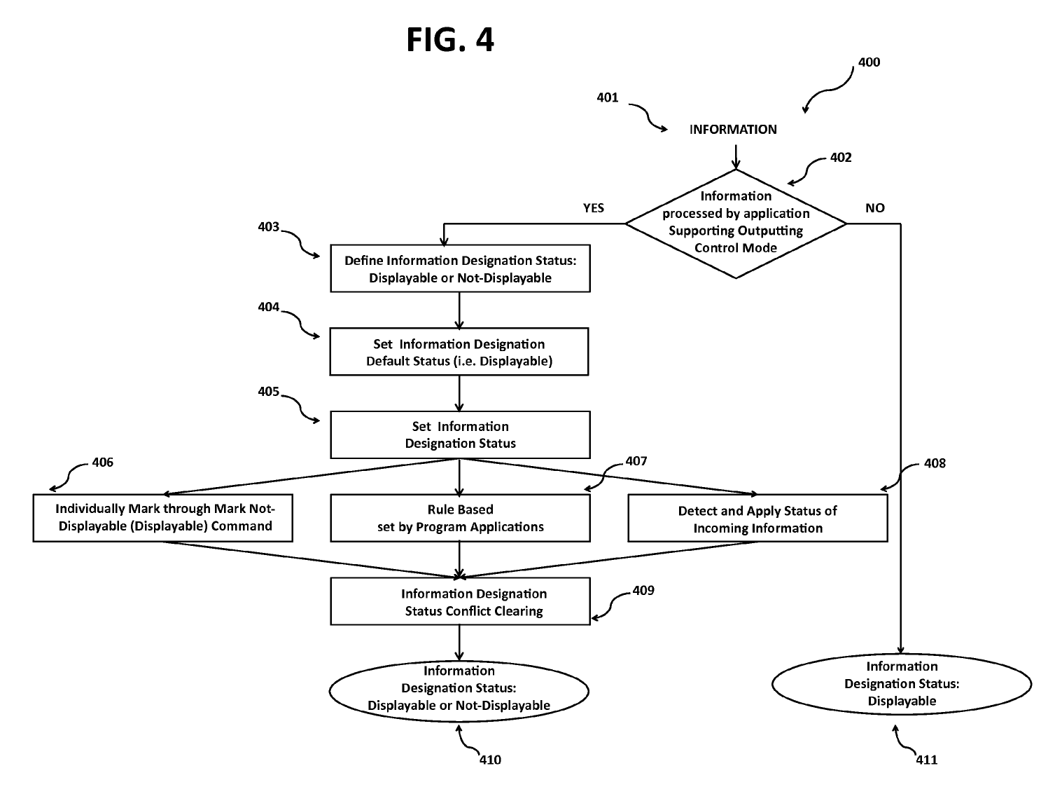

FIG. 4 is a flowchart illustrating a method 400 for allowing the user to designate the information status as either ‘Displayable’ or ‘Not-Displayable’, according to an exemplary embodiment of the present invention.

Mobile communication device and program applications generate, receive, store or process information 401 comprising audio, video and other sensorial contents, alerts, alarms and notifications.

In one embodiment of the invention, if information is generated, received, stored or processed by a computing device or a program application (step 401), that information status will be designated as ‘Displayable’ (step 411) if the computing device or program application is not detected or is not detectable by the outputting control mode functionalities. In other words, any information generated by an application or a device which does not support the outputting control mode is designated ‘Displayable’. For example: if a device embeds the outputting control mode functionalities and the user downloads an application which does not support outputting control mode, then all the information generated by this downloaded application will be deemed ‘Displayable’ on that device. Further, a device or a programme that does not support the outputting control mode in accordance with the invention is a computing device or a program application that cannot generate at least one data file that is designated as ‘Not-Displayable’, whose outputting is disabled when the outputting control mode is ‘ON’ and has at least one data file that is designated ‘Displayable’ whose outputting is disabled when outputting control mode is ‘OFF’.

In one embodiment of the invention, if information is generated, received, stored or processed by a computing device or a program application which supports the outputting control mode functionalities (as determined by instructions 402), then instructions 403 define the binary status of the information as ‘Not-Displayable’ or ‘Displayable’. This means that the information is detectable as ‘Not-Displayable’ or ‘Displayable’ when the outputting control mode selection is ‘ON’ or ‘REVERSE’.

Instruction 404 sets the default status of the information as ‘Displayable’, in which case the information status is by default designated as ‘Displayable’ unless is designated as ‘Not-Displayable’ in some other step.

In some implementations, instructions 405 sets the information status according to a plurality of information designation methods (as shown in steps 406, 407, and 408) as configured by the device and program applications supporting the outputting control mode functionalities, from which the information has been generated or transmitted. The manufacturer (in relation to built-in program application) and the programmer (in relation to any third party built-in or downloaded program application) decide whether to use one, or more or all the designation methods. For instance Text Messaging application 141 may include the possibility to designate an individual Text Message according to method 406 or according to method 407 by setting certain rules to automatically designate text message (e.g. any text message associated to a contact designated Not-Displayable is designated Not-Displayable) or both. It is outside the scope of the patent to anticipate what the rules can possibly be (this would be impossible) with very few exceptions which are expressively mentioned in the claim list.

Information designation method 406, a manual operation, sets the information designation status as ‘Displayable’ or ‘Not-Displayable’ by the method of manually designating information comprising an individual data file (e.g., a contact entry in an Address Book program application) or a group of data files (e.g., a list of contacts entries in an Address Book program application, grouped according to address book predetermined classifications). The information could be manually designated by the user as either ‘Not-Displayable’ or ‘Displayable’ by user commands activated though a graphics user interface within the application that is generating, receiving, storing or processing the information.

Information designation method 407, a rule based operation, sets the information designation status as ‘Displayable’ or ‘Not-Displayable’ by the method of designating information according to predetermined instructions (or rules) as set by the device or by the program application that has generated, received, stored or processed the information.

According to information designation method 407 in some implementations, information comprising audio, video and other sensorial contents, alerts, alarms and notifications generated by a telephone call of Telephone application 140 (see FIG. 1), by a text message of Text Messaging application 141 (see FIG. 1), by an email of Email application 142 (see FIG. 1) and other applications generating an audio or video communication associated with one contact entry included in the Address Book application 139 (see FIG. 1) designated ‘Not-Displayable’, upon receipt or transmission of the communication is designated as ‘Not-Displayable’ if the contact entry is designated ‘Not-Displayable’ and is designated ‘Displayable’ if the contact entry is not designated ‘Not-Displayable’. In some implementations Telephone Application 140 (see FIG. 1), Text Messaging application 141 (see FIG. 1), Email application 142 (see FIG. 1) and other communication application are configured to designate as ‘Not-Displayable’ a communication associated with a contact entry in the Address Book application 139 (see FIG. 1) designated as ‘Not-Displayable’ upon receipt or transmission of the communication and to designate as ‘Displayable’ a communication associated with one contact entry in the address book application which is not designated as ‘Not-Displayable’ upon receipt or transmission of the communication. To explain further, the outputting control mode (‘ON’, ‘REVERSE’, ‘OFF’) is a feature of the device (it could be embedded in a program, however, it is primarily a device operating mode, similarly to a ‘flight mode’ operating mode, to provide an analogy). The designation of the information (‘Displayable’, ‘Not-Displayable’) is set within each individual program application (manufacturer or third-party built-in program application and downloaded program application) generating the information: within each program application, the programmer decide what information can be designated and how. The outputting of the information (enabled, disabled) is a function of (a) the status of the information (‘Displayable’, ‘Not-Displayable’) set within the program application and (b) the device outputting control mode (‘ON’, ‘OFF’, ‘REVERSE’). For example, if Mr. Smith is designated in the address book as ‘Not-Displayable’ and if the outputting control mode is ‘ON’, then any text message from Mr. Smith will not be displayed until the outputting control mode is switched to ‘OFF’.

According to information designation method 407, in some implementations, a still photo or video 124 (see FIG. 1) downloaded or saved as an attachment to information designated ‘Not-Displayable’ is also designated as ‘Not-Displayable’ and a still photo or video downloaded or saved as an attachment to information that is not designated ‘Not-Displayable’ is designated as ‘Displayable’.

According to information designation method 407, in some implementations, a calendar entry generated by Calendar application 127 (see FIG. 1) tagged to one or more contacts included in the Address Book application 139 (see FIG. 1) of which at least one such contact is designated as ‘Not-Displayable’, is designated as ‘Not-Displayable’ and a calendar entry tagged to one or more contacts included in the Address Book application 139 (see FIG. 1) none of which is designated as ‘Not-Displayable’, is designated as ‘Displayable’.

Information designation method 408 sets the information designation status as ‘Displayable’ or ‘Not-Displayable’ by the method of detecting and assigning the designation status applied by other devices or program applications from which the information has been generated or transmitted. According to process 408, in some implementations an incoming telephone call of Telephone application 140 (see FIG. 1), an incoming text message of Text Messaging application 141 (see FIG. 1) or an incoming email of Email application 142 (see FIG. 1) which has been generated or transmitted by another device or program application as designated either ‘Displayable’ or ‘Not-Displayable’, is assigned the detected designation status. According to process 408, in some implementations a still photo or video of Photo application 124 (see FIG. 1), a note of Note application 125 (see FIG. 1), a calendar entry of Calendar application 127 (see FIG. 1) or a contact entry of Address Book application 139 (see FIG. 1) generated or transmitted by another device or program application as designated either ‘Displayable’ or ‘Not-Displayable’, is assigned the detected designation status.

After information status has been set according to one or more methods 406, 407 and 408 as configured by the device and program applications from which the information has been generated, received, stored or processed, instructions 409 also configured by the same device and program applications, resolves any conflicts between information status designation that may have occurred. As an exemplary conflict, an incoming text message from the Text Messaging application 141 (see FIG. 1) could be designated (a) ‘Displayable’ according to method 408 if transmitted by another device which has designated the text message as ‘Displayable’; (b) ‘Not-Displayable’ according to method 407 designating a text message ‘Not-Displayable’ if associated to a contact entry of Address Book 139 (see FIG. 1) designated as ‘Not-Displayable’; and (c) either ‘Displayable’ or ‘Not-Displayable’ by the manual operation of process 406. In some implementations, if the information status according to method 407 is set at ‘Not-Displayable’ and the information status according to method 408 is set at ‘Displayable’, instructions 409 set the information status in step 410 as ‘Not-Displayable’. In some implementation, if the information status according to method 407 is set to ‘Displayable’ and the information status according to method 408 is set to ‘Not-Displayable’, instructions 409 set the information status in step 410 as ‘Not-Displayable’. In some implementations, the instructions 409 provide that the information designation method 406 overrules the information designation methods 407 and 408 to designate the information status in step 410.

In some implementations, process 400 could be restricted to a subset of information 401 (e.g., the information can be only contents, only alerts, only alarms, only notifications or only any combination of contents, alerts, alarms and notifications) and further subsets (e.g., only audio notification, only video notification, only other sensorial notification or only any combination of audio, video and other sensorial notifications). This subset would still be processed according to the plurality of designation methods 406, 407 and 408 and conflict clearing 409 as defined within each individual program application 123-142 (see FIG. 1). Each application program can incorporate one or more or all of the methods and need to set its own rule on how to manage conflicts between different designations.

Each of the above identified instructions and applications can correspond to a set of instructions for performing one or more functions described above. These instructions need not be implemented as separate software programs, procedures or modules. The process and logic flaws described in this specification can be performed by one or more programmable processors executing one or more computer programs to perform functions by operating an input data and generating output. The process can also be implemented as, special purpose logic circuitry or any application-specific integrated circuit.

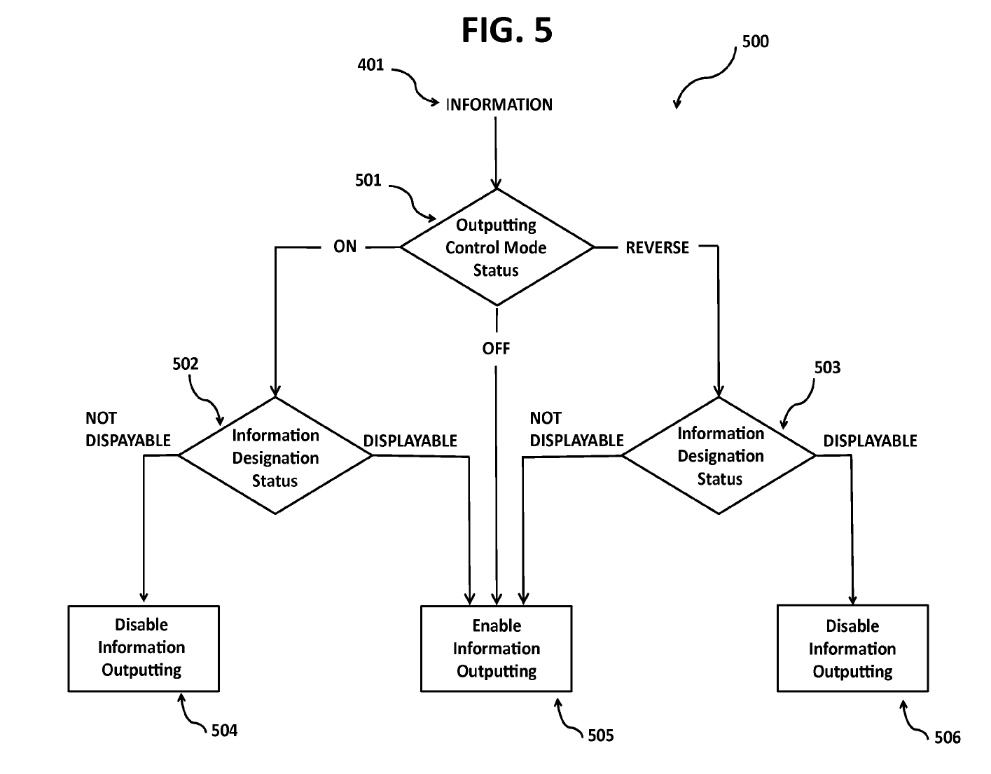

FIG. 5 is a flowchart illustrating a method 500 for enabling or disabling the outputting of information comprising audio, visual and other sensorial contents, alerts, alarms and notifications according to the outputting control mode (′ON′ or ‘OFF’ or ‘REVERSE’) and information designation status (‘Displayable’ or Not-Displayable′) according to an exemplary embodiment of the present invention.

If the outputting control mode status is ‘OFF’ at step 501, then instructions 505 enable the outputting of information.

If the outputting control mode status is ‘ON’ at step 501, then the outputting of information 401 is enabled or disabled depending on the status of the information at step 502 as ‘Displayable’ or Not-Displayable′: if information status at step 502 is ‘Not-Displayable’, then instructions 504 disable the outputting of the information; and if the information status at step 502 is ‘Displayable’ then instructions 505 enable the outputting of the information.

If the outputting control mode status is ‘REVERSE’ at step 501, then the outputting of information 401 is enabled or disabled depending on the status of the information at step 503 as ‘Displayable’ or ‘Not-Displayable’: if information status at step 503 is ‘Not-Displayable’, then instructions 505 enable the outputting of the information; and if the information status at step 503 is ‘Displayable’ then instructions 506 disable the outputting of the information. Thus, in accordance with an embodiment of the present invention, when the outputting control mode is selected as ‘ON’, the processor is configured to disable output including alarms, alerts and notification associated with a data file designated as ‘Not-Displayable’ and when the outputting control mode is selected as ‘REVERSE’, the processor is configured to disable output including alarms, alerts and notification associated with a data file which is not designated as ‘Not-Displayable’.

In some implementations of the embodiments, the device flashes its LED 109 (see FIG. 1) or a visual information is provided in the status bar 122 (see. FIG. 1) and 152 (see FIG. 1) or any alternative acoustic or visual or other sensorial information is displayed or output to signal that the outputting of new ‘Not-Displayable’ information has been disabled in the outputting control mode ‘ON’ or the outputting of new ‘Displayable’ information has been disabled in the outputting control mode ‘REVERSE’.

Each of the above identified instructions and applications can correspond to a set of instructions for performing one or more functions described above. These instructions need not be implemented as separate software programs, procedures or modules. The process and logic flaws described in this specification can be performed by one or more programmable processors executing one or more computer programs to perform functions by operating an input data and generating output. The process can also be implemented as, special purpose logic circuitry or any application-specific integrated circuit.

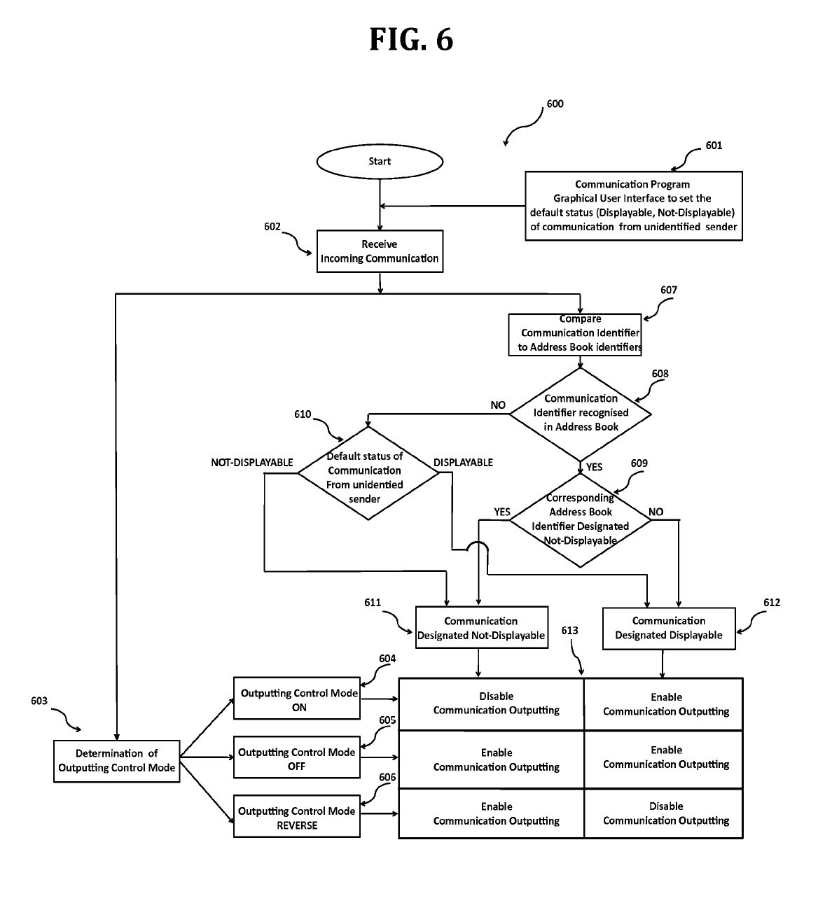

FIG. 6 is a flowchart illustrating a method 600 for enabling or disabling the outputting of information according to methods 400 and 500, wherein the program application is an application that processes a telephone call of Telephone application 140 (see FIG. 1), a text message of Text Messaging application 141 (see FIG. 1), an email of Email application 142 (see FIG. 1) and other incoming communications.

Instructions 603 determine whether the outputting control mode selection is ‘ON’ (step 604), ‘OFF’ (step 605) or ‘REVERSE’ (step 606). Instructions 601 set, though the user graphical interface 207 (see FIG. 2A), the default designation status as either ‘Displayable’ or ‘Not-Displayable’ of the record of a communication from a sender, whose identifier does not correspond to the identifier of any contact stored in Address Book application 139 (see FIG. 1).

Instructions 602 receive a communication from a sender, the communication including an identifier of the sender and instructions 607 compare the identifier of the sender of the communication with the identifiers of the contacts stored in Address Book 139 (see FIG. 1). Instructions 608 check whether or not the identifier of the sender corresponds to the identifier of any contact stored in Address Book application 139 (see FIG. 1): if the identifier of the sender of the communication does not correspond to the identifier of any contact stored in Address Book application 139 (see FIG. 1), instructions 610 set a record of the communication and designate the record of the communication as either ‘Not-Displayable’ (step 611) or ‘Displayable’ (step 612) according to the default status set in step 601.

If the identifier of the sender corresponds to the identifier of at least one contact stored in Address Book application 139 (see FIG. 1), instructions 609 designate the record of the communication as ‘Displayable’ or ‘Not-Displayable’: if the identifier of the sender corresponds to at least one identifier of a contact stored in Address Book application 139 (see FIG. 1) which is designated ‘Not-Displayable’, instructions 611 set a record of the communication and designate the record of the communication as ‘Not-Displayable’ (step 611); and if the identifier of the sender corresponds to the identifier of one or more contacts stored in Address Book application 139 (see FIG. 1) none of which are designated ‘Not-Displayable’, instruction 612 save a record of the communication and designate the record of the communication as ‘Displayable’.

Instructions 613 enable or disable the outputting of the communication as a function of the status of (a) the designation of the communication (‘Displayable’ or ‘Not-Displayable’) as determined in step 611 and 612 and (b) the outputting control mode (‘ON’, ‘OFF’ or ‘REVERSE’) as determined in step 604, 605 and 606: (i) enabling outputting of the communication if the record of the communication is designated either ‘Displayable’ or ‘Not-Displayable’ when the outputting control mode selection is ‘OFF’; (ii) enabling outputting of the communication if the record of the communication is designated ‘Displayable’ and disabling the outputting of communication if the record of the communication is designated as ‘Not-Displayable’ when the outputting control mode selection is ‘ON’; and (iii) enabling outputting of the communication if the record of the communication is designated ‘Not-Displayable’ and disabling the outputting of communication if the record of the communication is designated as ‘Displayable’ when the outputting control mode selection is ‘REVERSE’.

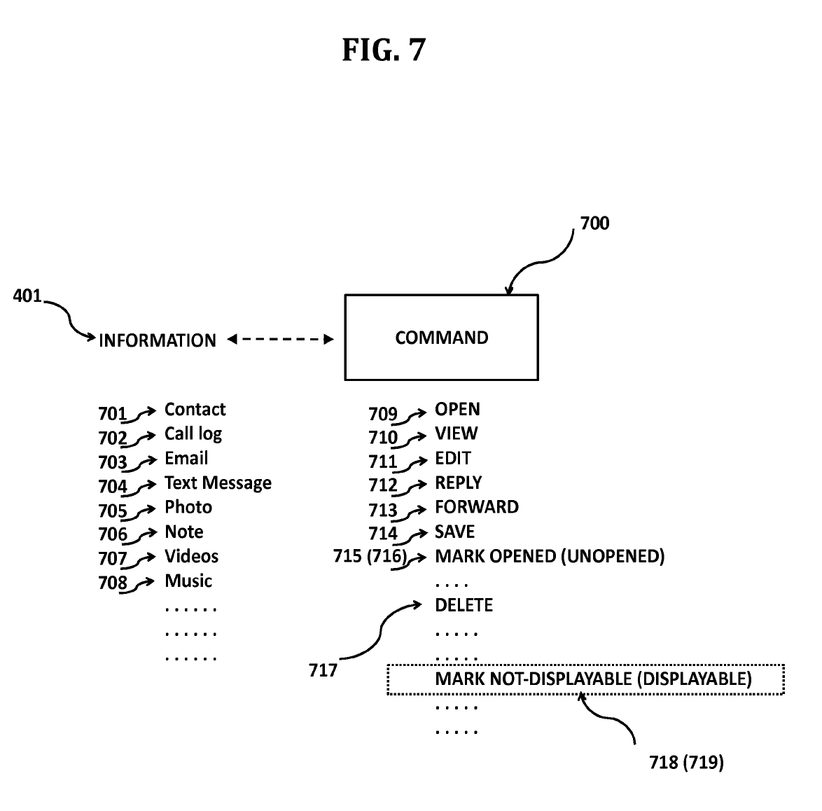

FIG. 7 illustrates an example implementation method of a user command to toggle information or the device and program application process to generate information between being designated as either ‘Displayable’ or ‘Not-Displayable’.

Mobile communication device and program applications generate information 401 (FIG. 4) comprising audio, visual and other sensorial contents, alerts, alarms and notifications. In some implementations of mobile communication device 100 (see FIG. 1), the information may include contacts data 701, call logs 702, email 703, text messages 704, photo 705, notes 706, video 707, music 708 and other types of data. In order to manage such information, in some implementations of the mobile communication device 100 (see FIG. 1), program applications include user commands 700 that can be activated through the device graphical interface. Such commands include, for example, open 709, view 710, edit 711, reply 712, forward 713, save 714, alternatively reversible mark opened (unopened) 715(716), delete 717 and other known commands.

In one embodiment of the invention, the manual operation of process 406 (see FIG. 4) can be activated through the alternatively reversible user command 718 (719), subsequently referred as ‘Mark Displayable’ (‘Mark Not-Displayable’) enabling individual information (e.g., an individual contact entry, email, text message, still photo or video) or a group of information (e.g., list of contacts entries of the Address Book application 139 grouped according to a predetermined classification generated by the application, or a collection of still photo of Photo application 124 grouped into an album generated by the application) to be toggled between being designated as either ‘Displayable’ or ‘Not-Displayable’. For example, most email programs (or text messaging programs) allow users to designate an individual email ‘Read’ (‘Unread’) with a ‘Mark as Read’ (‘Mark as Unread’) user command: the ‘Mark Displayable’ (Mark Not-Displayable) command performs the equivalent functionality in relation to the designation of information as ‘Not-Displayable’ (‘Displayable’) for the purpose of the control outputting functionality.

In another embodiment of the invention, the manual operation of process 406 (see FIG. 4) is activated through the alternatively reversible user command 718 (719) ‘Mark Displayable’ (′Mark Not-Displayable′) enabling the device and program applications process of generating information to be toggled between as either generating information designated ‘Displayable’ or generating information designated ‘Not-Displayable’. As an exemplary embodiment, a Camera application 123 (see FIG. 1) configured either as ‘Mark Not-Displayable’ or ‘Mark Displayable’ designate photo taken with the camera as either ‘Not-Displayable’ or ‘Displayable’ according to the corresponding ‘Mark Not-Displayable’ or ‘Mark Displayable’ configuration. To recap the “Mark Not Displayable” (‘Mark Displayable’) command has two uses as described in the previous two paragraphs, respectively: (a) to toggle information (e.g. an individual email) between being designated as either Displayable or Not-Displayable; and (b) toggle the process of generating information (e.g. a Camera application) between either as generating information designated Displayable or generating information designated Not-Displayable. Specifically, at least one program application comprises an alternatively reversible user command subsequently referred as ‘Mark Displayable’ (′Mark Not-Displayable′) enabling individual information or group of information to be toggled between being designated as either ‘Displayable’ or ‘Not-Displayable’, wherein a data file generated by the application being configured ‘Mark Displayable’ is designated as ‘Displayable’ and a data file generated by the application being configured ‘Mark Not-Displayable’ is designated as ‘Not-Displayable’.

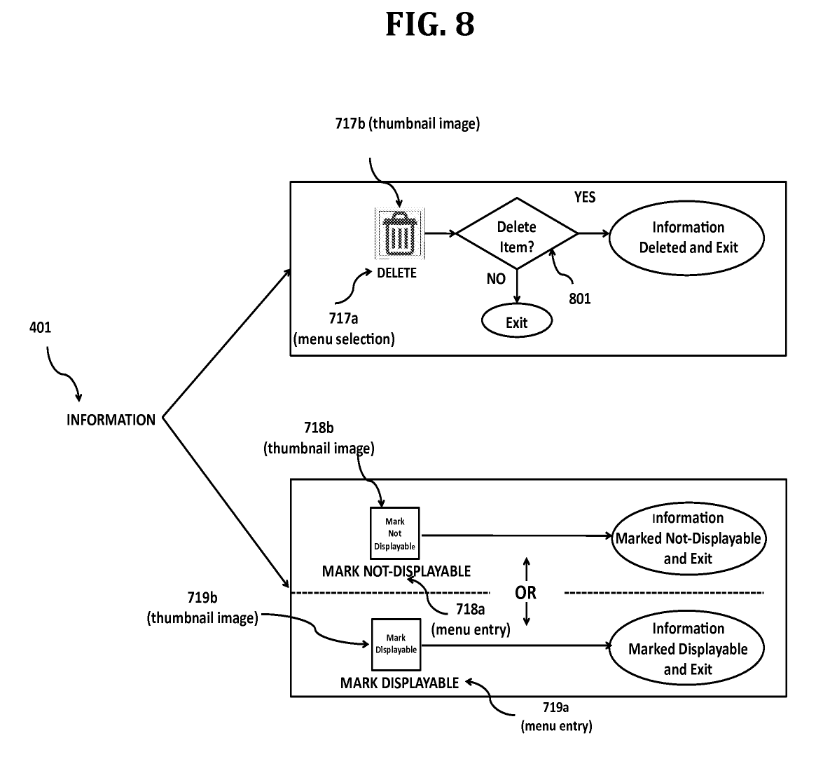

FIG. 8 illustrates an example embodiment of a graphical interface for the user command ‘Mark Not-Displayable’ (‘Mark Displayable’) 718 (719) (see FIG. 7) to toggle information between being designated as either ‘Displayable’ or ‘Not-Displayable’.

In some implementations, applications include a graphical interface for activating a ‘delete’ command to erase information either as a menu entry selection (717a) or as a thumbnail image selection (717b). Confirmation is generally required through instructions 801 as ‘delete’ is an irreversible instruction.

In some implementations, an alternatively reversible command ‘Mark Not-Displayable’ (‘Mark Displayable’) is added to one, more than one or all corresponding delete commands in the application, according to the method that a deletable information can also be toggled between being designated as either ‘Displayable’ or ‘Not-Displayable’.

In some implementations, a ‘delete’ command 717 (see FIG. 7) requires a confirmation 801. In one embodiment of the invention, no confirmation is required when activating the ‘Mark Not-Displayable’ (‘Mark Displayable’) command, as this is an alternatively reversible command.

In one embodiment of the invention, application Camera 123 (see FIG. 1), Photo 124 (see FIG. 1), Note 125 (see FIG. 1), Web Browser 126 (see FIG. 1), Calendar 127 (see FIG. 1), Setting 130 (see FIG. 1), Address Book 139 (see FIG. 1), Telephone 140 (see FIG. 1), Text Messaging 141 (see FIG. 1), Email 142 (see FIG. 1), and/or any other native or third party native and not native application that supports the outputting control mode functionalities, has a graphical interface hosting an alternatively reversible ‘Mark Not-Displayable’ (menu entry 718a or thumbnail image 718b selection) and a ‘Mark Displayable’ command (menu entry 719a or thumbnail image 719b selection) added to the graphical interfaces hosting the corresponding ‘delete’ command (menu entry 717a or thumbnail image 717b selection).

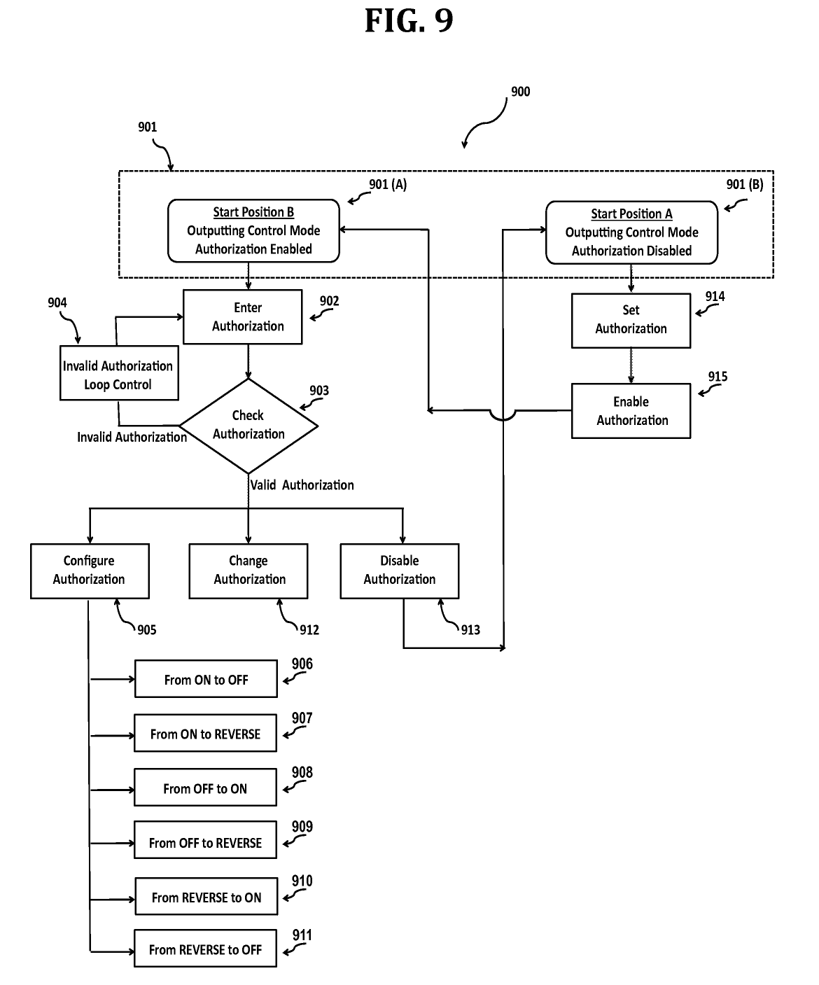

FIG. 9 illustrates an example implementation method for outputting control mode instructions 900 to configure (905), set (914), change (912), enable (915), disable (913) valid authorization for outputting control mode being permitted to switch from at least one configuration to another (e.g. from outputting control mode ‘ON’ to ‘OFF’).

If outputting control mode authorization is disabled (901 A), outputting control mode is permitted to switch from one configuration to another without the user being required to enter valid authorization. Instructions 914 allow the user to set a valid authorization and instructions 915 to enable such authorization being required for outputting control being permitted to switch from at least one configuration to another.

If outputting control mode authorization is enabled (901 B), instructions 905, 912 and 913 allow to configure (905), change (912) and disable (913) authorization, subject to verifying valid authorization as per instructions 902 and 903: If an invalid authorization is entered, instructions 905, 912 and 913 are not permitted until a valid authorization is entered, with loop control 904 setting instructions (e.g., freeze the device) after an invalid authorization is entered for a predefined number of times (e.g., ten).

Instruction 905 comprise instructions 906, 907, 908, 909, 910 and 911 to configure the computing device outputting control mode to require authorization be permitted to switch from one or more configurations from ‘ON’ to ‘OFF’ (906), from ‘ON’ to ‘REVERSE’ (907), from ‘OFF’ to ‘ON’ (908) from ‘OFF’ to ‘REVERSE’ (909), from ‘REVERSE’ to ‘ON’ (910) and from ‘REVERSE’ to ‘OFF’ (911).

Each of the above identified instructions can correspond to a set of instructions for performing one or more functions described above. These instructions need not be implemented as separate software programs, procedures or modules. The process and logic flaws described in this specification can be performed by one or more programmable processors executing one or more computer programs to perform functions by operating an input data and generating output. The process can also be implemented as, special purpose logic circuitry or any application-specific integrated circuit.

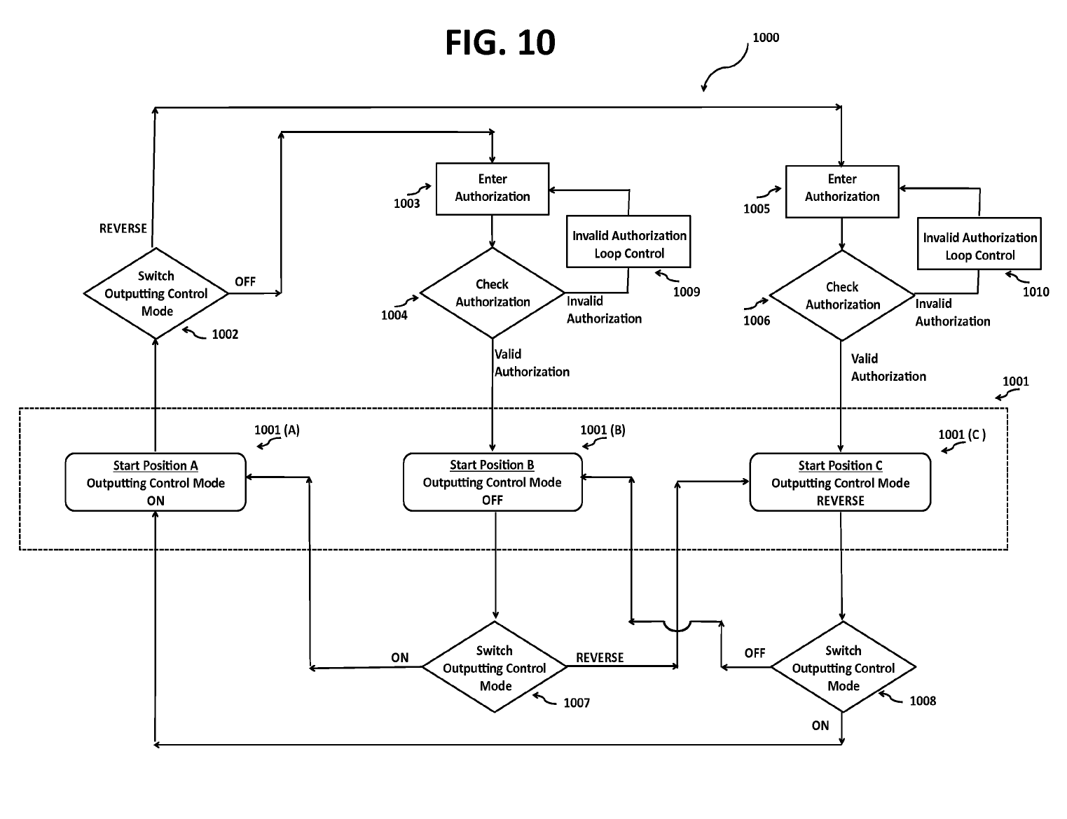

FIG. 10 is a flowchart illustrating an example of an implementation method 1000 for the outputting control mode being permitted to switch configuration after entering valid authorization as enabled with process 900 (see FIG. 9).

The computing device outputting control mode is at any time in a start position 1001, which could be one of the three modes ‘ON’ (1001 A), ‘OFF’ (1001 B) and ‘REVERSE’ (1001C).

If the start position of computing device outputting control mode is ‘ON’ (1001 A), in step 1002 the user can switch the outputting control mode into ‘REVERSE’ or into ‘OFF’. In this case, the user is required to enter authorization (step 1003, step 1005) and subject to check validity of the authorization (step 1004, step 1006), the outputting control mode is switched into the new start position ‘OFF’ (1001 B) or ‘REVERSE’ (1001 C). If an invalid authorization is entered, outputting control mode ‘ON’ is not permitted to be switched into ‘OFF’ or ‘REVERSE’ until a valid authorization is entered, with loop control (1009, 1010) setting instructions (e.g. freeze the device) after an invalid authorization is entered for a predefined number of times (e.g. ten).

If the start position of computing device outputting control mode is ‘OFF’ (1001 B), in step 1007 the user can switch the outputting control mode into ‘ON’ or ‘REVERSE’, in which case the outputting control mode is switched into a new start position ‘ON’ (1001 A) or ‘REVERSE’ (1001 C) without being required to enter valid authorization. If the start position of computing device outputting control mode is ‘REVERSE’ (1001 C), in step 1008 the user can switch the outputting control mode into ‘ON’ or ‘OFF’ in which case the outputting control mode is switched into a new start position ‘ON’ (1001 A) or ‘OFF’ (1001 B) without being required to enter valid authorization.

In other embodiments, valid authorization is required to switch outputting control mode status from and to other configurations (e.g. from ‘REVERSE’ to ‘ON’, from ‘REVERSE’ to ‘OFF’, etc.).

The outputting control mode authorization setting and verification process can be implemented according to any method of device authorization setting process including but not limited to requiring a password such as a series of alphanumerical characters; a specific series of acts, such as a predefined series of mouse clicks in a particular region(s) of a display; and/or the output of biometric such as a finger print reader, voice recognition and/or an iris scan.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, e.g., one or more modules of computer program instructions encoded on a non-transitory computer-readable medium for execution by, or to control the operation of, a data processing apparatus. The non-transitory computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus and which is stored on a computer readable medium.

A computer program (also known as a program application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Therefore, it is to be understood that the invention is not to be limited to the specific aspects disclosed and that modification and other aspects are intended to be included within the scope of appended claims.

What is claimed is:

1. A computing device, comprising a memory, a processor, an operating system, I/O peripherals and a plurality of resources connected to the processor for exchanging signals therewith being configurable between an outputting control mode of ‘ON’, ‘OFF’ and ‘REVERSE’; an input device connected to the processor for inputting an outputting control mode selection via a graphical interface; instructions operable on the processor for causing the processor
(a) when the outputting control mode selection is ‘OFF’, to enable the outputting of information to a data file in the memory when the information is either not designated or is designated as either ‘Displayable’ or Not-Displayable′;
(b) when the outputting control mode selection is ‘ON’, to disable the outputting of information to a data file in the memory when the information is designated as ‘Not-Displayable’ and to enable the outputting of information to a data file in the memory when information is not designated ‘Not-Displayable’; and
(c) when the outputting control mode selection is ‘REVERSE’, to disable the outputting of information to a data file in the memory when the information is not designated as ‘Not-Displayable’ and to enable the outputting of information to a data file in the memory when the information is designated as ‘Not-Displayable’ wherein the outputting control mode selection is configured to require valid authorization data for switching from at least one configuration to another and to enable at least one data file in the memory to be toggled between being designated ‘Not-Displayable’ or ‘Displayable’.

2. The computing device of claim 1, comprising an input device connected to the processor for inputting an information designation status as ‘Displayable’ or ‘Not-Displayable’ and instructions operable on the processor for causing the processor to designate a data file in the memory either ‘Displayable’ or ‘Not-Displayable’ according to predetermined instructions or by detecting and adopting the designation status associated with the data file as applied by a computing device.

3. The computing device of claim 1, wherein the outputting control mode selection ‘ON’ is configured to disable the outputting of a data file designated as ‘Not-Displayable’ or metadata associated with the data file designated as ‘Not-Displayable’ and the outputting control mode selection ‘REVERSE’ is configured to disable the outputting of a data file which is not designated as ‘Not-Displayable’ or metadata associated with the data file which is not designated as Not-Displayable′.

4. The computing device of claim 1, further comprising an address book application and at least one communication application configured to designate as ‘Not-Displayable’ a communication associated with at least one contact entry in the address book application designated as ‘Not-Displayable’ upon receipt or transmission of the communication and to designate as ‘Displayable’ a communication associated with at least one contact entry in the address book application which is not designated as ‘Not-Displayable’ upon receipt or transmission of the communication.

5. The computing device of claim 1, further comprising at least one program application comprising an alternatively reversible user command subsequently referred as ‘Mark Displayable’ (‘Mark Not-Displayable’) enabling individual information or group of information to be toggled between being designated as either ‘Displayable’ or ‘Not-Displayable’ wherein a data file generated by the application being configured ‘Mark Displayable’ is designated as ‘Displayable’ and a data file generated by the application being configured ‘Mark Not-Displayable’ is designated as Not-Displayable′.

6. The computing device of claim 1, wherein when the outputting control mode is selected as ‘ON’, the processor is further configured to disable output including alarms, alerts and notification associated with a data file designated as ‘Not-Displayable’ and when the outputting control mode is selected as ‘REVERSE’, the processor is further configured to disable output including alarms, alerts and notification associated with a data file which is not designated as ‘Not-Displayable’.

7. The computing device of claim 6, wherein the data file designated as ‘Not-Displayable’ is a contact from an address book, and the alarm, alert and notification indicate reception of a communication from the contact.

8. A method to control the outputting of information on computing devices and program applications the computing devices comprising a process and a computer-readable non-transitory memory, the program applications being stored in the memory in the form of computer readable instructions, the method comprising a process to designate information as ‘Displayable’ or ‘Not-Displayable’ and to designate an outputting control mode as ‘OR’ or ‘OFF’ or ‘REVERSE’, the process implemented by the instructions configured to:
(a) to enable outputting to a data file in the memory which is not designated or is designated as either ‘Displayable’ or ‘Not-Displayable’ when the outputting control mode selection is ‘OFF’;
(b) to disable outputting to a data file in the memory designated as ‘Not-Displayable’ and to enable outputting to any data file in the memory which is not designated ‘Not-Displayable’ when the outputting control mode selection is ‘ON’; and
(c) to disable outputting to a data file in the memory which is not designated ‘Not-Displayable’ and to enable outputting to a data file in the memory designated as ‘Not-Displayable’ when the outputting control mode selection is ‘REVERSE’,
wherein the outputting control mode selection is configured to require valid authorization data for being permitted to switch from at least one configuration to another and to enable at least one data file in the memory to be toggled between being designated as ‘Not-Displayable’ or ‘Displayable’.

9. The method of claim 8, wherein the information designation method is a user command to manually designate an individual data file or a group of data files.

10. The method of claim 8, wherein the information designation method is a program application configured to designate data files according to predetermined instructions.

11. The method of claim 8, wherein the information designation method is the process to detect and apply the designation assigned to a data file by a device from which the data file has been transmitted.

12. The method of claim 8, wherein the outputting control mode selection ‘ON’ is configured to disable the outputting of a data file designated as ‘Not-Displayable’ or metadata associated with the data file designated as ‘Not-Displayable’ and the outputting control mode selection ‘REVERSE’ is configured to disable the outputting of a data file which is not designated as ‘Not-Displayable’ or metadata associated with the data file which is not designated as ‘Not-Displayable’.

13. The method of claim 9, wherein the data file is configured to be toggled between being designated as ‘Displayable’ and designated as ‘Not-Displayable’ through a user selectable alternatively reversible ‘Mark Displayable’ and ‘Mark Not-Displayable’ command that is selectable through a graphical user interface, wherein the selection input using the graphical use interface causes the processor to enable or disable the outputting of the data file according to a predetermined outputting control mode selection ‘ON’ or ‘OFF’ or ‘REVERSE’.

14. The method of claim 13, wherein the graphical user interface includes a plurality of inputs including a specified menu entry selection and a thumbnail selection.

15. The method of claim 10, wherein the program application is an application that processes incoming communications, the application further comprising:
determining whether the outputting control mode selection is ‘ON’, ‘OFF’ or ‘REVERSE’;
setting through a user graphical interface the default designation status as either ‘Displayable’ or ‘Not-Displayable’ of the record of a communication from a sender whose identifier does not correspond to the identifier of any contact stored in an address book application;
receiving a communication from a sender, the communication including an identifier of the sender;
comparing the identifier of the sender of the communication with the identifiers of a set of contacts stored in an address book application;
if the identifier of the sender of the communication does not correspond to the identifier of any contact stored in an address book application, saving a record of the communication and designating the record of the communication as either ‘Displayable’ or ‘Not-Displayable” according to the setting of default designation status;
if the identifier of the sender corresponds to at least one identifier of a contact stored in an address book application which is designated ‘Not-Displayable’, saving a record of the communication and designating the record of the communication as ‘Not-Displayable’;
if the identifier of the sender corresponds to the identifier of one or more contacts stored in an address book application, none of which is designated ‘Not-Displayable’, saving a record of the communication and designating the record of the communication as ‘Displayable’;
enabling outputting of the communication if the record of the communication is designated either ‘Displayable’ or ‘Not-Displayable’ when the outputting control mode selection is ‘OFF’;
enabling outputting of the communication if the record of the communication is designated ‘Displayable’ and disabling the outputting of communication if the record of the communication is designated as ‘Not-Displayable’ when the outputting control mode selection is ‘ON’; and
enabling outputting of the communication if the record of the communication is designated ‘Not-Displayable’ and disabling the outputting of communication if the record of the communication is designated as ‘Displayable’ when the outputting control mode selection is ‘REVERSE’.

16. The method of claim 15, further comprising the steps of:
if the record of the communication is designated as ‘Not-Displayable’, disabling access to the record of the communication when the outputting control mode selection is ‘ON’ and if the record of the communication is designated as ‘Displayable’, disabling access to the record of the communication when the outputting control mode selection is ‘REVERSE’.

17. The method of claim 15, wherein the communication is selected from at least one of a telephone call, an email, or a text message.

18. The method of claim 15, wherein outputting of the communication comprises an acoustic alert, alarm or notification.

19. The method of claim 15, wherein outputting of the communication comprises displaying text or an icon on a display device.

20. The method of claim 8, wherein the program application comprises a user selected binary setting mode of ‘Mark Displayable’ or ‘Mark Not-Displayable’ that is selectable through a graphical user interface, where the selection input by the graphical interface causes the application to designate as ‘Displayable’ a data file or a group of data files generated by the application in the setting mode ‘Mark Displayable’ and to designate as ‘Not-Displayable’ a data file generated by the application in the setting mode ‘Mark Not-Displayable’.
